(19) United States
(12) Patent Application Publication
(10) Pub. No.: US 2018/0189643 A1
(43) Pub. Date: Jul. 5, 2018

(54) CONVOLUTION CIRCUIT, APPLICATION PROCESSOR INCLUDING THE SAME, AND OPERATING METHOD THEREOF

(71) Applicant: Electronics and Telecommunications Research Institute, Daejeon (KR)

(72) Inventors: Chan KIM, Daejeon (KR); Young-Su KWON, Daejeon (KR); Jin Ho HAN, Seoul (KR)

(73) Assignee: Electronics and Telecommunications Research Institute, Daejeon (KR)

(21) Appl. No.: 15/847,466

(22) Filed: Dec. 19, 2017

(30) Foreign Application Priority Data
Jan. 5, 2017 (KR) 10-2017-0001967

(51) Int. Cl. G06N 3/063; G06N 3/04; G06N 3/08; G06K 9/46; G06K 9/66

(52) U.S. Cl. CPC G06N 3/063; G06N 3/04; G06K 9/66; G06K 9/4604; G06N 3/08

(57) ABSTRACT

Provided is an operation method of a convolution circuit. The method includes receiving input feature maps, generating output feature maps corresponding to the respective input feature maps through convolution operations for performing parallel processing with a kernel unit, and outputting the output feature maps to an external memory.

### CROSS-REFERENCE TO RELATED APPLICATIONS

This U.S. non-provisional patent application claims priority under 35 U.S.C. § 119 to Korean Patent Application No. 10-2017-0001967, filed on Jan. 5, 2017, in Korean Intellectual Property Office, the entire contents of which are incorporated herein by reference.

### FIELD OF THE INVENTION

The present disclosure relates to a convolution circuit, an application processor including the same, and an operating method thereof.

### BACKGROUND

Deep learning includes preprocessing, feature extraction, and feature selection in neural networks through a method of directly learning feature extracting parameters based on multilayer artificial neural networks. Among various deep learning algorithms, a deep learning algorithm widely used in image analysis is a convolutional neural network model. Convolutional neural network (CNN) is a machine learning model based on in-depth supervised learning, and is strong in application and robust to local feature extraction and classification. Because of the weighted shared structure feature, the CNN model is designed to be more similar to the biological neural network and achieves excellent accomplishment in a pattern recognition field.

### SUMMARY

The present disclosure provides a convolution circuit applicable to an application processor and a method thereof.

An embodiment of the inventive concept provides an operation method of a convolution circuit: receiving input feature maps; generating output feature maps corresponding to the respective input feature maps through convolution operations for performing parallel processing with a kernel unit; and outputting the output feature maps to an external memory.

In an embodiment, the kernel unit may include K×K window filtering (K is a natural number).

The method may further include storing each of the input feature maps in an internal memory of a chip corresponding to K lines.

In an embodiment, the generating of the output feature maps may include storing kernels necessary for generating the output feature maps in the external memory.

In an embodiment, the method may further include repeating loading and accumulating a partial sum of the convolution operation from the external memory, or storing the partial sum in the external memory.

In an embodiment, at least one of the parallel processing convolutions may use a physically different memory for its data multiplied by the kernel weights.

In an embodiment, result values of each of the parallel processing convolutions may be stored in the external memory in a predetermined order.

In an embodiment, at least one of the convolution operations may be performed while outputting at least one of the output feature maps to the external memory.

In an embodiment, a plurality of feature map data may be output at the same time while receiving the plurality of feature map data from the external memory.

In an embodiment of the inventive concept, a convolution circuit includes: a direct memory access (DMA) processing unit configured to read data from an external memory or output data to the external memory; a kernel buffer configured to store kernel data for connecting an input feature map being processed and N (N is a natural number of 2 or more) output feature maps; a bottom buffer configured to store a plurality of input data corresponding to an input feature map; an input data load unit configured to transmit the N kernel data from the DMA processing unit to the kernel buffer; a kernel/data supply unit configured to output P (P is a natural number of 2 or more) K×K input data of the bottom buffer and P K×K kernel data of the kernel buffer; a pipeline parallel kernel processing unit configured to perform a convolution operation by using K×K kernel weight values for each P kernel processing; a result reception unit configured to receive a result value of the pipeline parallel kernel processing unit; a partial top buffer configured to store the intermediate result values; and a control unit configured to control the DMA control unit, the kernel buffer, the bottom buffer, the input data load unit, the kernel/data supply unit, the pipeline parallel kernel processing unit, the result reception unit, and the partial top buffer.

In an embodiment, the DMA processing unit may include: a read first-in, first-out (FIFO) memory configured to store a plurality of input feature map data and kernel data from the external memory; and a write FIFO memory configured to store a plurality of output feature map data to be written in the external memory.

In an embodiment, the kernel buffer may be implemented as a dual port random access memory (DPRAM) for storing the N kernel data and outputting the P kernel data for parallel processing at the same time.

In an embodiment, the kernel buffer may load kernel data from the external memory in an order of an input feature map, and load kernel data to a memory in an order of processing output feature maps when processing the input feature map, wherein a storage order of each kernel data may be to store the kernel data with a row unit first and then store the kernel data with a column unit in each row.

In an embodiment, the kernel buffer may allocate a different physical memory for each row of a kernel.

In an embodiment, the kernel buffer may collect the K weight values from the read FIFO memory and store the K weight values in a corresponding memory.

In an embodiment, the bottom buffer may output all data in a kernel window at the same time while the kernel window for input data moves in the input feature map.

In an embodiment, the kernel/data supply unit may read input data corresponding to the kernel window from the bottom buffer according to a row and column index of an output feature map and read the P kernel data for processing the data read from the kernel buffer.

In an embodiment, the pipeline parallel kernel processing unit may output the P result values by performing a multiplication operation and an addition operation on the input data and corresponding kernel weight values delivered from the kernel/data supply unit.

In an embodiment, the convolution circuit may further include an output data storage unit configured to read intermediate result values from the partial top buffer and transmit the read intermediate result values to the write FIFO memory of the DMA processing unit.

In an embodiment of the inventive concept, an operation method of an application processor includes: performing parallel convolution operations on each of input feature maps to extract features; and performing sub-sampling operations on each of result values of the parallel convolution operation to extract the features, wherein the performing of the parallel convolution operations includes outputting intermediate result values to an external memory at the same time while receiving input data from the external memory.

### BRIEF DESCRIPTION OF THE FIGURES

FIG. 1 is a view illustrating a convolution concept diagram in a general convolutional neural network.

FIG. 2 is a view illustrating an exemplary convolution using a 3×3 kernel.

FIG. 3 is a view illustrating an exemplary convolution scheme according to an embodiment of the inventive concept.

FIG. 4 is a view illustrating an exemplary convolution parameter according to an embodiment of the inventive concept.

FIGS. 5A and 5B illustrate exemplary convolution processing timing diagrams according to an embodiment of the inventive concept;

FIG. 6 is a view illustrating an exemplary convolution circuit according to an embodiment of the inventive concept.

FIGS. 7A, 7B, and 7C are views illustrating a configuration method of a kernel buffer according to an embodiment of the inventive concept.

FIG. 8 is a view illustrating a 3×3 kernel to create N output feature maps in one input feature map according to an embodiment of the inventive concept.

FIG. 9 is a view illustrating an example of a method of inputting kernel data and writing it into a kernel buffer according to an embodiment of the inventive concept.

FIG. 10 is a view illustrating an example of an index of input data according to an embodiment of the inventive concept.

FIG. 11 is a view illustrating an example of a physical memory number selected by an index of input data according to an embodiment of the inventive concept.

FIG. 12 is a view illustrating an address to be stored in the selected physical memory according to an embodiment of the inventive concept;

FIG. 13 is a view illustrating an example of an index calculation of other values from a kernel center index according to an embodiment of the inventive concept.

FIG. 14 is a view illustrating an exemplary structure of a kernel processor according to an embodiment of the inventive concept.

FIG. 15 is a view illustrating a mobile device according to an embodiment of the inventive concept.

FIG. 16 is a flowchart illustrating an operation method of an application processor according to an embodiment of the inventive concept.

### DETAILED DESCRIPTION

In the following, the contents of the inventive concept will be described clearly and in detail with reference to the drawings so that those skilled in the art easily carry out the inventive concept.

Embodiments according to the inventive concept may have various modifications and various forms, so they are illustrated in the drawings and described in detail herein. However, this does not limit various embodiments of the inventive concept to a specific embodiment and it should be understood that the inventive concept covers all the modifications, equivalents, and/or replacements of the inventive concept provided they come within the scope of the appended claims and their equivalents.

It will be understood that the terms “first” and “second” are used herein to describe various components but these components should not be limited by these terms. The terms are used only for the purpose of distinguishing one component from another and for example, without departing from the scope of the invention concept, a first component may be referred to as a second component and similarly a second component may also be referred to as a first component.

When it is mentioned that a certain component is “coupled with” or “connected with” another component, it should be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween. Other expressions that describe the relationship between components, such as “between” and “directly between” or “adjacent to” and “directly adjacent to”, should be interpreted in the same manner.

In various embodiments of the inventive concept, terms used in this specification are used to describe specific embodiments, and are not intended to limit the scope of the inventive concept. The singular expressions include plural expressions unless the context clearly dictates otherwise. Additionally, in various embodiments of the inventive concept, the term “include,” “comprise,” “including,” or “comprising,” specifies a property, a region, a fixed number, a step, a process, an element and/or a component but does not exclude other properties, regions, fixed numbers, steps, processes, elements and/or components.

Otherwise indicated herein, all the terms used herein, which include technical or scientific terms, may have the same meaning that is generally understood by a person skilled in the art. In general, the terms defined in the dictionary should be considered to have the same meaning as the contextual meaning of the related art, and, unless clearly defined herein, should not be understood abnormally or as having an excessively formal meaning.

Convolutional neural network (CNN) is basically a fully-connected neural network that constitutes the connection pattern of neurons. The CNN basically includes a convolutional layer, a pooling layer, and a fully-connected layer. The convolutional layer is a layer that extracts features through convolution operations. The pooling layer is a layer for abstracting an input space. For example, if the number of pixels is large in the case of image data, the pooling layer performs dimensionality reduction through a sub-sampling process or the like. The fully-connected (or inner-product) layer is applied last to the topmost layers and classifies the features delivered from the bottom layer.

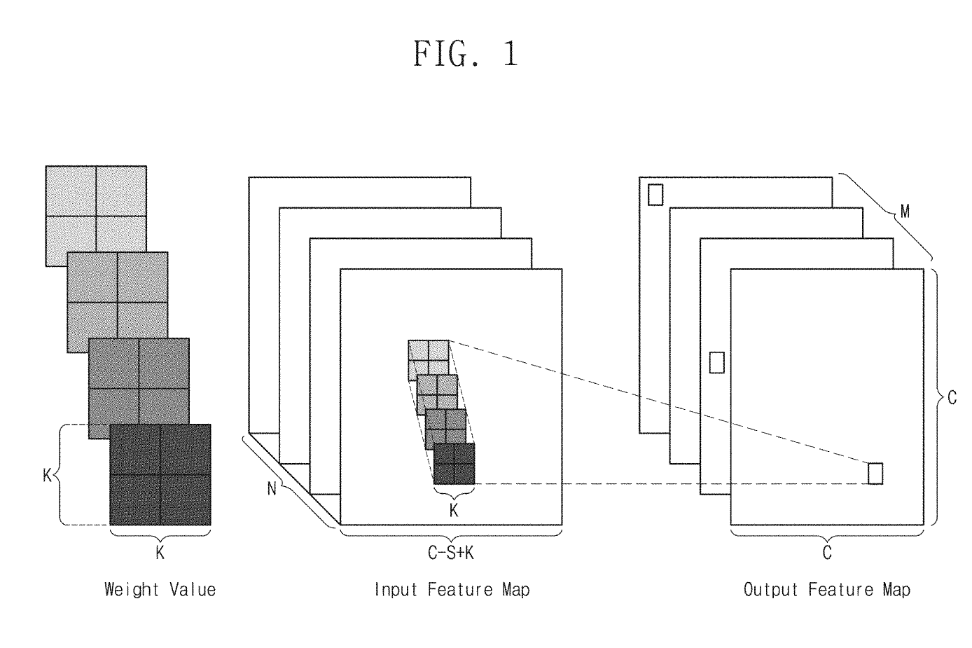

FIG. 1 is a view illustrating a convolution scheme having N (where N is a natural number equal to or greater than 2) inputs and M (M is a natural number equal to or greater than 2) output feature maps. Recently, CNN is mainly used for image recognition. The largest amount of computation in the CNN is the convolution operation. The CNN includes several convolutional layers. In the inventive concept, it is assumed that each convolutional layer receives the inputs of M input feature maps and outputs N output feature maps. Between one input feature map and one output map, there is a K×K (K is a natural number) kernel for that. Actually, the number of K×K kernels is M×N. It is assumed that a convolution circuit according to an embodiment of the inventive concept receives M input feature maps in an external memory and generates N output feature maps in the external memory using M×N K×K kernels in the external memory. The M means the number of input feature maps.

The actual convolution adds one bias value defined for each output feature map to every value of each output feature map. In the convolution for CNN, the input includes M feature maps, and the output includes N feature maps. Each of the input and output feature maps has a width Wi, a height Hi, a width Wo, and a height Ho. Also, to make N outputs from these M inputs, the K×K kernel is used. The K×K kernel is a rectangular shape whose width is K and height is K and has K×K weight values. As each pair of input feature maps and output feature maps has a different kernel, there are M×N K×K kernels.

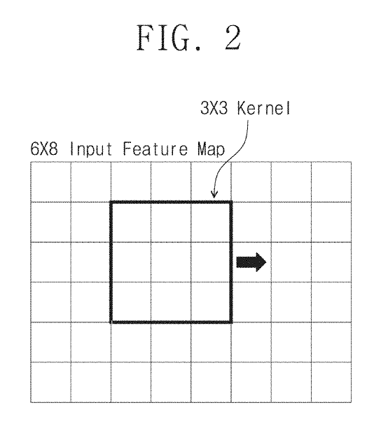

FIG. 2 is a view illustrating a convolution using a 3×3 kernel. Scanning is performed from the top line to the bottom line of the input feature map based on a center of the kernel. Also, the scanning is performed from left to right in each line. A kernel weight value is respectively multiplied to data overlapping the window while the scanning is performed. The results of multiplications are added and an output value of one point of the output feature map is generated.

The final value of data of an output feature map is obtained by adding the values processed by the kernel connecting the output feature map and each input feature map to all input feature maps and then adding a bias value corresponding to the output feature map. This final value depends on the corresponding kernel area data. Also, the final value depends on the M K×K kernel values corresponding to respective input feature maps. Recently, image recognition using the CNN improves performance by adding the features of various processing methods together with a network configuration.

The convolution circuit according to an embodiment of the inventive concept may be implemented so as to be applicable to an application processor (AP). The convolution circuit according to an embodiment of the inventive concept may use deep learning in an AP including a central processing unit (CPU) core. The convolution circuit according to an embodiment of the inventive concept may be implemented so as to process arithmetic operations quickly without using a large-capacity memory. The convolution circuit according to an embodiment of the inventive concept aims to have a relatively short processing time through parallel processing while using a minimum memory.

A convolution circuit according to an embodiment of the inventive concept reads an input feature map, generates all the output data using the read input feature map, and does not reload the same input feature map data for minimizing the memory requirement in the chip. One input feature map is used to create all the output feature maps.

A CNN according to an embodiment of the inventive concept creates all the feature maps by accumulating the partial sums sequentially and in parallel output feature map groups by applying one input feature map at a time. This invention's CNN creates one data of all the output feature maps and then store the intermediate result value in the external memory. When processing the next input feature map, The CNN reads the intermediate result value back and accumulates the kernel-processed result values.

Although all the output feature maps are processed at the same time, a unit that writes and reads intermediate result values processes data for one point at the same position of the output feature maps, rather than one line or an entire feature map of an output feature map. Thus, the on-chip memory requirement for an output feature map is very small. In the method of repeatedly reading the input feature map, since the amount of data used in the kernel is large due to the size of the K×K kernel, the memory access time and the memory capacity in the chip are increased. Therefore, a CNN according to an embodiment of the inventive concept uses all of the read input feature maps so as not to load them again, and instead uses a method of writing the intermediate result value of the output feature map and reading it again.

In addition, a CNN according to an embodiment of the inventive concept may reduce a space for storing kernel weight values by reading and processing only the kernel data for processing a current input feature map being processed. In kernel processing, a CNN according to an embodiment of the inventive concept may process several output feature maps simultaneously. For this purpose, the kernel weight value uses an appropriate size and number of memories considering the bit width of memory data allowed in a semiconductor process so as to simultaneously read as many kernel values as necessary.

The kernel processing unit is a point unit of the output feature map. Therefore, K×K input data is required. However, after reaching the end of one row and then returning to the first position of the next row again, data of one or more above rows previously processed should be used again according to the size of the kernel. In consideration of this, rows necessary for the K×K kernel operations are read and maintained, and newly read rows are overwritten at the positions of oldest used rows so that K rows are always maintained in the chip. Thus, the memory requirement for storing input data during an operation is K×Wi.

In addition, a parallel circuit is used during kernel processing to fully follow the time for reading from and writing to memory. That is, simultaneously generating the values of the same point of the P output maps with respect to the input data is repeated. In an embodiment, P may be 2. In another embodiment, a P value greater than 2 may be used if the internal operating clock speed is lower than the external memory access speed.

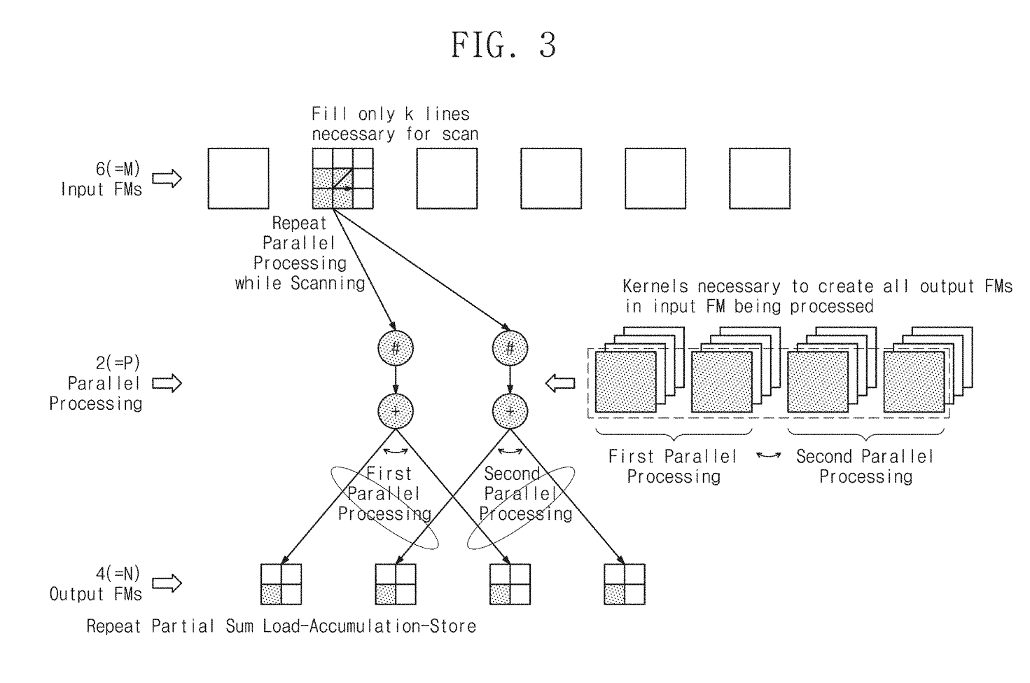

FIG. 3 is a view illustrating an exemplary convolution scheme according to an embodiment of the inventive concept. Referring to FIG. 3, four output feature maps are generated from six input feature maps using two parallel processes.

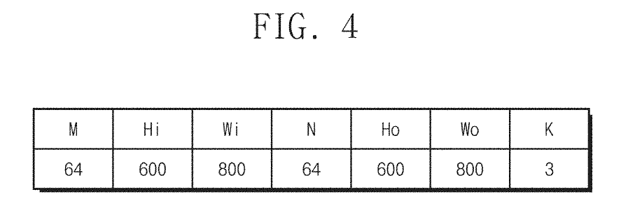

FIG. 4 is a view illustrating an example of parameters of a convolutional layer according to an embodiment of the inventive concept. Referring to FIG. 4, M is 64, Hi is 600, Wi is 800, N is 64, Ho is 600, Wo is 800, and K is 3.

When it is assumed that the external memory uses double data rate 3rd generation (DDR3) and uses 1600 MT/s (800 MHz clock) and 32 bit, it provides 6400 MBps speed. Then, when it is also assumed that the internal processing clock is 800 MHz, the memory interface uses 128 bits, and the parallel processing is 2, the processing order and estimated time for generating all the output feature maps for one input feature map in the convolutional layer having the above-mentioned parameters are shown as follows.

Because the memory access time depends on the speed of DDR3 regardless of the chip's internal interface, the memory access time is a calculated value based on the speed of DDR3. Also, two lines should be read at the beginning to make 3×3 convolution possible. However, since the below is for the average calculation, the time of the convolution is calculated for a line typically located in the middle.

1. N K×K kernel read time: For example, with 64×3×3=575 words, the processing time is 0.36 μs.

2. One line read time: with 800 words, the processing time is 0.5 μs.

3. Convolution processing time for one line: the processing time is 64 μs (=repeated sum of below 3-1 to 3-3).

3-1. Partial sum points read time: with 64 words, the processing time is 0.04 μs (˜32 clocks).

3-2. Convolution (output 64 words) time for input one point: With 64 outputs/2 parallels=32 clocks, the processing time is 0.04 μs.

3-3. Partial sum points write time: with 64 words, the processing time is 0.04 μs (˜32 clocks). Double parallel processing is sufficient.

Reading+convolution+writing (progressing in the way of writing the last processed point result while calculating a new point) of the above 3-1, 3-2, and 3-3 is repeated. The total time is ˜800×0.04×2=64 μs. The above-described processes 2 to 3 are repeated.

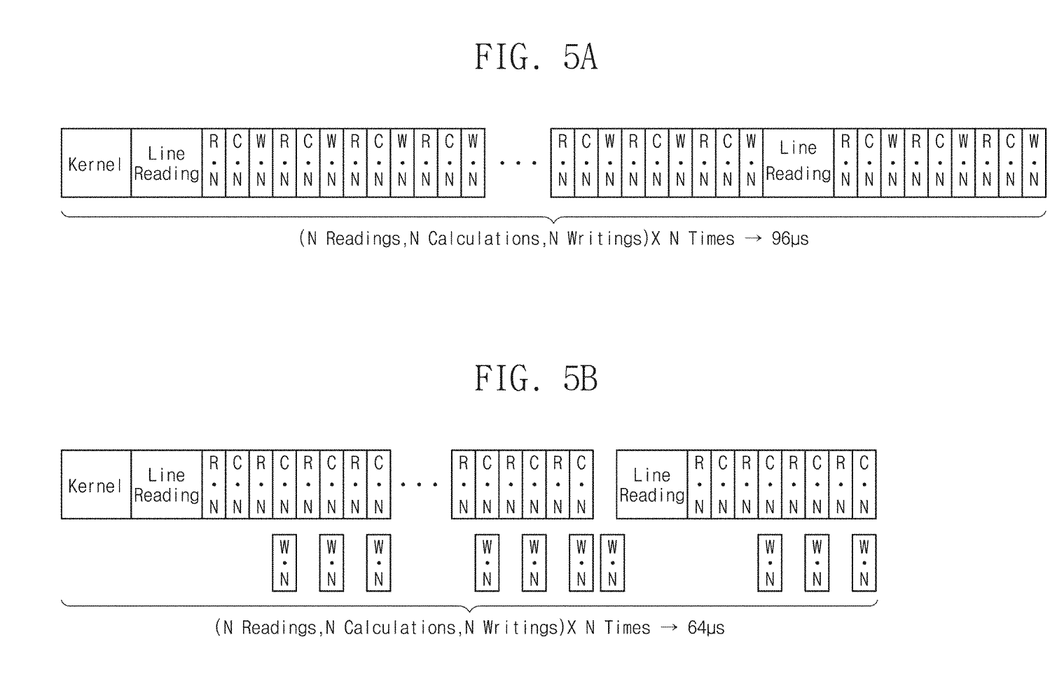

FIGS. 5A and 5B illustrate exemplary convolution processing timing diagrams according to an embodiment of the inventive concept. Referring to FIG. 5A, in the case of simplifying the convolution process described above, the overall process may have the form of FIG. 5A. In the drawings, R-N means reading N data (N partial sums), C-N means creating N data, and W-N means writing N data (N partial sums). However, referring to FIG. 5B, if the control of the processing operation is appropriately adjusted, it is also possible to write the above-processed result to the external memory while processing the convolution as shown in FIG. 5B. In this case, the overall processing time may be reduced.

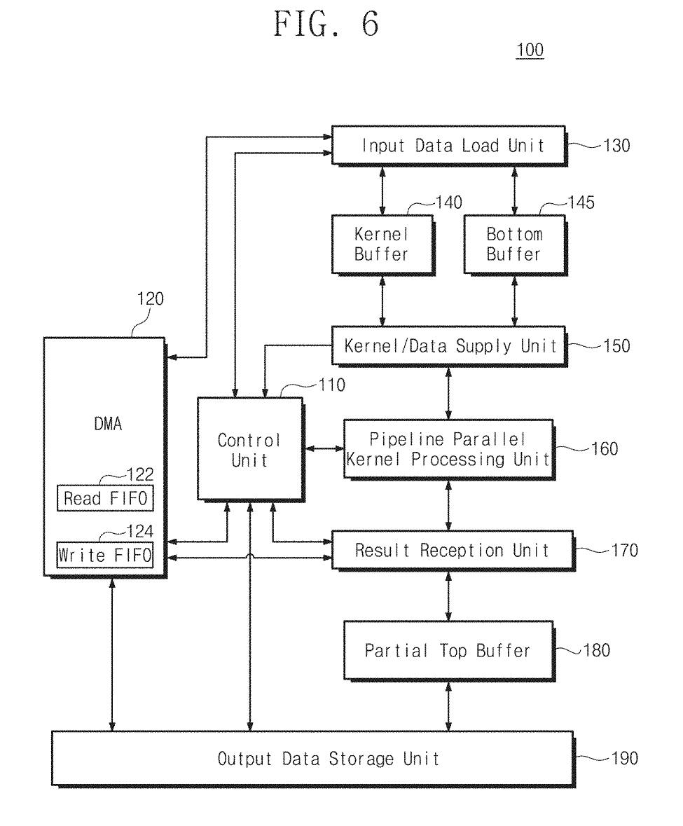

FIG. 6 is a view illustrating an exemplary convolution circuit 100 according to an embodiment of the inventive concept. Referring to FIG. 6, the convolution circuit 100 includes a control unit 110, a DMA processing unit 120, an input data load unit 130, a kernel buffer 140, a bottom buffer 145, a kernel/data supply unit 150, a pipeline parallel kernel processing unit 160, a result reception unit 170, a partial top buffer 180, and an output data storage unit 190.

The control unit 110 may be implemented to set various parameters and trigger operations or check states through a processor core through Advanced Peripheral Bus (APB) interface. The control unit 110 may also be implemented to perform an operation required in the core by generating various interrupts according to the operation. The number (M) of input feature maps (FM), the number (N) of output feature maps (FM), the height Hi and the width Wi of the input feature map (FM), and the height Ho and the width Wo of the output feature map (FM) may be provided to the entire block through the register file of the control unit 110.

The control unit 110 may be implemented to receive commands/instructions of the central processing unit (CPU) and instruct overall convolution. For example, the control unit 110 may select the input feature maps sequentially using a state machine and a counter, and instruct the DMA processing unit 120 and the input data load unit 130 to read a kernel for processing such input feature maps from the external memory.

In addition, the control unit 110 may also control the DMA processing unit 120 and the input data load unit 130 to read each line of the input feature map at a necessary time point.

Also, the control unit 110 may instruct the DMA processing unit 120 and the result reception unit 170 to read each intermediate result (partial sum) value.

In addition, the control unit 110 may instruct the DMA processing unit 120 to write the calculated intermediate result value to the external memory. Such an indication and a corresponding completion report may generally be made by sending request signal with parameters and receiving a done signal with a status in general. Thereafter, this overall processing sequence will be discussed in detail in the description of the input data load unit 130, the kernel/data supply unit 150, the result reception unit 170, and the external memory.

The DMA processing unit 120 may be implemented to receive a start command together with a start address of data to be read from the control unit 110 and the number of data, and read data from an advanced eXtensible interface (AXI) (the maximum burst is adjustable), and transmit the data to a buffer input unit during a loop.

The DMA processing unit 120 may include first-in-first-out (FIFO) for 128-bit width DMA read and FIFO for DMA write. During the DMA read operation, when there is data in the read FIFO, the data load unit 130 reads data and transmit the data to the final destination memory. When the data load unit 130 reads the last data, DMA read is regarded as completed. During the DMA write operation, the output data storage unit 190 writes the result data to the write FIFO when there is an empty space in the write FIFO, and when all the corresponding data has been transmitted through the AXI, DMA write is regarded as completed.

When data is input from an external memory, data may be input together with a strobe signal with a 128 bit data (4 words) unit. When data is input from the AXI, it may not be input with full 4 words. In consideration of this, input data should be stored in the DMA read FIFO, and may be managed in 32-bit word units to increase the number of stored words when writing data input from the AXI.

The data loading unit 130 may reduce the counter with a 32 bit word unit when reading data from the DMA read FIFO. In the same manner, when data is output to an external memory, the data is output with a 128 bit data (4 words) unit. When data is output to the AXI, it may not be output with full 4 words. Therefore, in consideration of that, when reading data from the DMA write FIFO and transmitting the data to the AXI or writing data output from an external memory to the DMA write FIFO, the counter is to be managed in word units.

The data loading unit 130 may know a start of the DMA using the information output from the control unit 110. Furthermore, if there is data in the DMA read FIFO of the DMA processing unit 120, the data loading unit 130 reads the data from the FIFO until the target data transfer is completed and fills the data in the kernel buffer 140 or the bottom buffer 145. Here, “kerneling” means both K×K multiplications and adding their results (and adding parallel results too).

Since the next memory read should proceed even during the kerneling process, the K×K kernel buffer 140 for the kernel data and the input data may be implemented as a dual port memory. That is, one side port may read and process data, and the other side port may overwrite the data at a new position. Since replacing kernel values is relatively infrequent, there is no significant performance penalty even if double buffering is not used for the kernel buffer 140.

The kernel buffer 140 may be implemented to store N K×K kernel data to be used for each of N output FMs with respect to an input FM currently being processed, and output P K×K values for parallel processing at the same time.

According to an embodiment of the inventive concept, P K×K kernel weight values may be changed and may be provided for different output FMs each clock so that P parallel processors perform kerneling through pipelining each clock.

If the number of bits of one data is W (W=32 for single precision) and the degree of parallel processing is P (e.g., P=16), the kernel buffer 140 may simultaneously provide P K×K values as one pair. If these values are written in one memory, the data width is P×K×K×W bits and the depth is N/P. Therefore, in most cases, the width is too large to be written (in the case of K=5, P=2, and N=512, the width is 1,600, the depth is 256, and the number of memory is 1). In order to reduce the width of the memory, if a separate memory is used for each output feature map (FM), there are P memories having a width of K×K×W and a depth of N (when K=5, P=2, and N=512, the width is 320, the depth is 512, and the number of memories is 2).

All the methods may be used, but K×P memories having a width of 32×K and a depth of N may be used by further dividing the memory and allocating separate memory for each row of each kernel (when K=5, P=2, and N=512, the width is 160, the depth is 512, and the number of memories is 10).

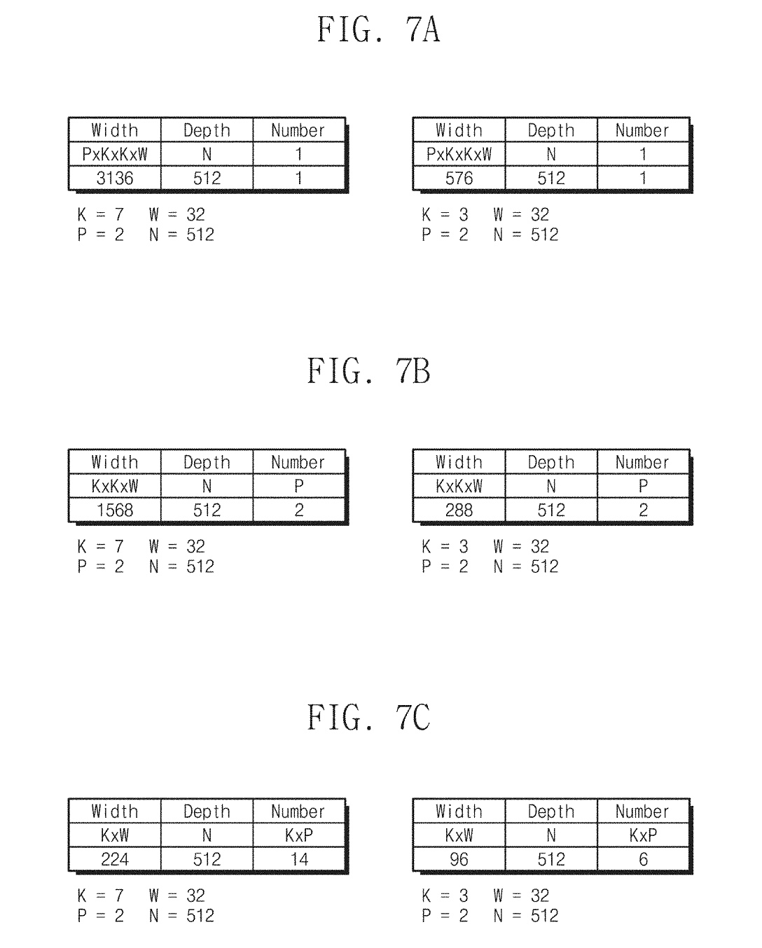

FIG. 7 is a view illustrating an exemplary configuration method of the kernel buffer 140 according to an embodiment of the inventive concept. Referring to FIG. 7, the width, depth, and number of memories used in the above three methods are shown for two convolution cases.

Since input FMs are sequentially processed, it is assumed that when kernel data is stored in an external memory, the kernel data is stored first, in the order of the input feature map (FM), and then in the order of each output FM within the order of each input feature map (FM, feature map), and is stored first with the row order in each kernel data, and then with the column unit in each row (called a row major). However, other methods are possible within the spirit of the inventive concept.

In order to load the kernel into a different physical memory for each row, the kernel data read through the DMA may be collected with a row unit and written by calculating the memory and address to be stored considering a parallel processing unit.

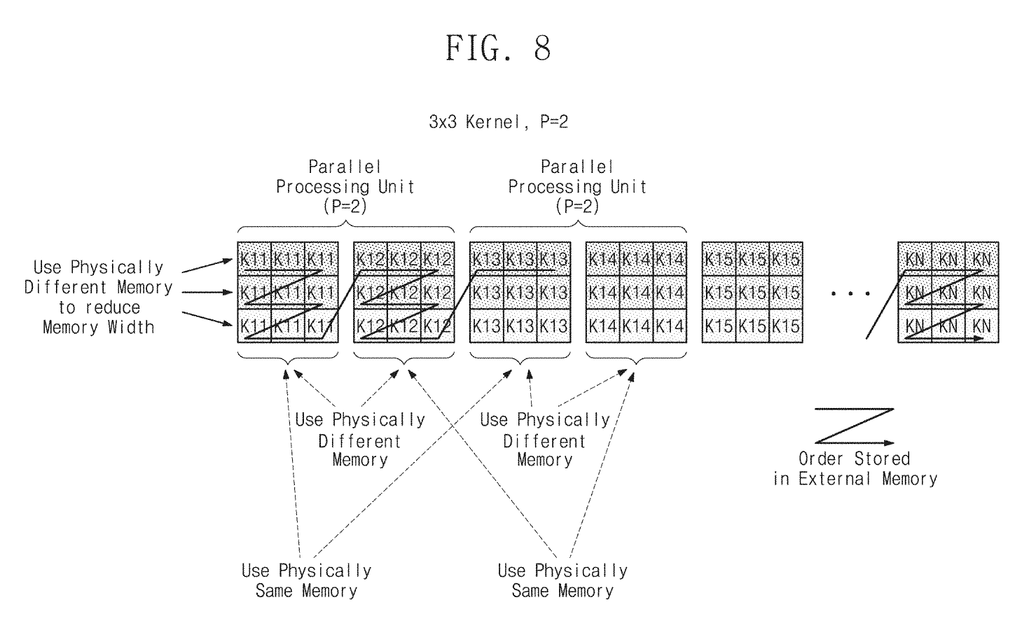

FIG. 8 is a view illustrating an exemplary 3×3 kernel to create N output FMs (partial sums) from one input FM according to an embodiment of the inventive concept. Referring to FIG. 8, in the case of the 3×3 kernel, there are N kernels that connect a specific input FM to the N output FMs as follows. As shown in FIG. 8, kernel data for the same parallel processing unit may be stored in different kernel buffers. Additionally, even if the kernel weight data belongs to the same kernel, if they are in different rows, the parallel processing unit kernel may be stored in different memories. Also, arrows show the order in which data is stored in the external memory.

In order to write to the above-described kernel buffer 140, the K weight values for parallel processing units may be gathered while observing the AXI DMA input data, and may be written to the address corresponding to the parallel processing order by selecting one of the K×P DPRAMs. That is, the first K weights value may be written to the address 0 of the memory corresponding to the parallel 0 of the row 0, the next K weight values may be written to the address 0 of the memory corresponding to the parallel 0 of the row 1, the next K weight values may be written to the address 0 of the memory corresponding to the parallel 0 of the row 2, . . . , the next K weight values may be written to the address 0 of the memory corresponding to the parallel 0 of the row K−1, the next K weight values may be written to the address 0 of the memory corresponding to the parallel 1 of the row 0, the next K weight values may be written to the address 0 of the memory corresponding to the parallel 1 of the row 1, . . . , and the next K weight values may be written to the address 0 of the memory corresponding to the parallel 1 of the row K−1, and so on.

Also, the depth of the kernel buffer 140 should be N which is the number of the output FMs. However, in the case of P parallels, the depth of each memory is N/P. In the case of single precision (SP), the width of the 128-bit AXI is 4 words. If the number of kernel weight values for a parallel processing unit, that is, K×K×P, is not a multiple of 4 (in the case of P=2, always), at least each 2×K×K×P may be a multiple of 4. Therefore, it is possible to write by selecting a memory and an address in a pre-calculated pattern for K×K×P or 2×K×K×P for given K and P. For example, in the case of K=3 and P=2, it is possible to determine which data is to be grouped with period of 36 words, that is, 9 128-bit data, and to which memory the data is to be written, and using the value to increase the address, and write kernel data to the corresponding kernel buffer dual-port random access memory (DPRAM).

There are various methods of allowing P kernels to be output at the same time for the input order and parallel processing of kernel data input through the 128 bit AXI bus from an external memory through the DMA, and allowing the data width of each DPRAM to be K×P. That is, this is a method of storing it in a physical memory by using a separate physical memory for each row of the kernel.

FIG. 8 is a view illustrating an example of a method of inputting kernel data and writing it into a kernel buffer according to an embodiment of the inventive concept. Referring to FIG. 8, for parallel processing, the kernel buffer 140 may simultaneously output P (e.g., P=2) K×K kernel values among N K×K kernel values each clock and may apply P K×K kernel values to the pipeline parallel processing unit 160 that process convolution operation. Here, N may be a maximum of 512. Accordingly, the kernel buffer 140 may first store the kernel weight values read from the external memory into the chip's internal kernel buffer DPRAM according to the above-mentioned method, and select the desired P kernel data each clock when performing the actual kernel processing.

As described above, in consideration of the word width and the number of words of a memory, K×P memories each having a width of K×32 may be used in the case of single precision. Here, when the maximum K is 7 and P is 2, the width becomes 224 and the number is 14.

The data input from the DMA processing unit 120 has four weights at a time in case of 128 bits and single precision. The kernel weight values input from the DMA processing unit 120 may be collected into K words and may be written to the memory responsible for a corresponding row at the corresponding parallel positions 0 to P−1 in the K×K kernel while increasing an address through the use of counter while fetching the kernel data.

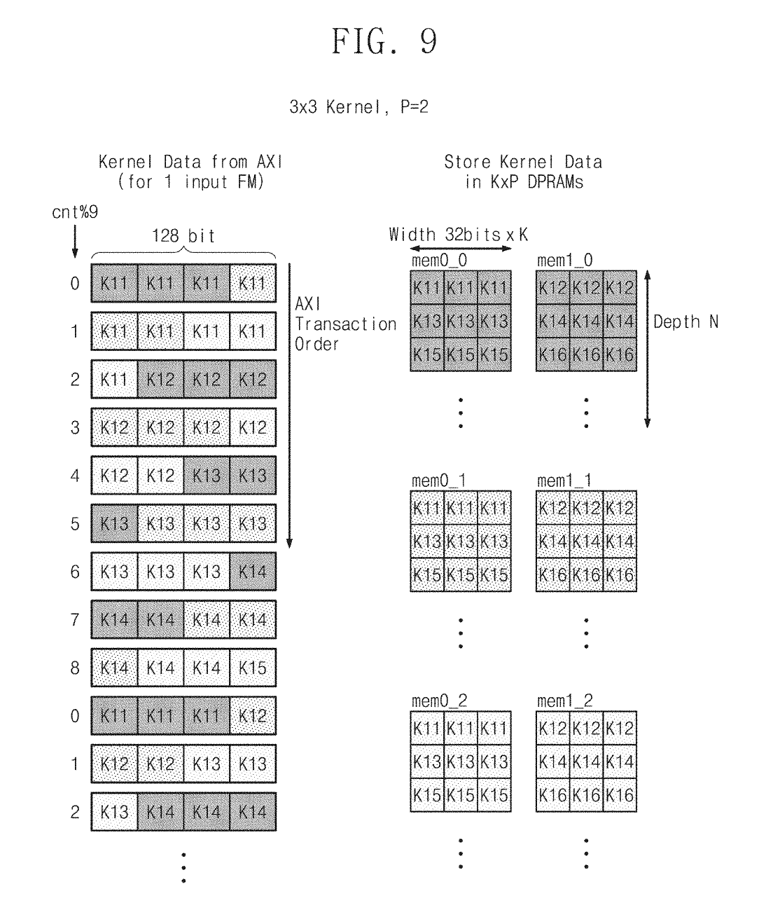

FIG. 9 is a view illustrating an exemplary kernel buffer write rule (in case of K=3 and 128 bit AXI) according to an embodiment of the inventive concept.

The write operation to a bottom K-line buffer, that is, the bottom buffer 145, is as follows. When a kernel window moves, the bottom buffer 145 should output all K×K data in its window simultaneously. Therefore, the bottom buffer 145 may have a limitation that the data that is to be covered by the K×K window is always stored in a physically separate memory. In addition, since only K lines need to be stored, the total capacity is K×Wi. However, since the total capacity is divided and stored in K×K memories, the depth of each memory is K×Wi/(K×K), that is, Wi/K (actually Wi may not be divided by K and therefore, it becomes ┌(Wi+1)/K┐). When implementing the actual convolution circuit 100, K, N, and Wi should use the maximum value in all cases where handling is possible. The configuration of the data memory is expressed as follows.

TABLE 1

| Kernel | Parallel | Preci- | Input | Input | | | |
|---|---|---|---|---|---|---|---|
| size | processing | sion | number | width | Width | Depth | Number |
| K | P | W | M | Wi | W | [Wi/K] | K × K |
| 7 | 2 | 32 | 512 | 800 | 32 | 115 | 49 |
| 3 | 16 | 32 | 64 | 800 | 32 | 267 | 9 |

When storing the bottom data in the K×K memories, one (Mi, i=0 to K×K−1) of the K×K memories where data is to be written is selected by a method described later. By calculating an address for storing the data in the selected memory and storing the data and reading data with the same method when reading the data, even if the kernel moves, it is possible to output the desired data at the same time.

When P K×K kernel values are output from the kernel buffer 140 and the data is output from the K×K memories in the bottom buffer 145, the pipeline kernel processing unit 160 may multiply and process the K×K kernel weight values and the data as pairs. As described above, values multiplied by the K×K window among data in a line buffer (data having a height of K and a width of Wi) may be simultaneously retrieved. Therefore, the values should be always physically stored in different memories. This is possible by placing the original input data in a two-dimensional plane having a height of Hi and a width of Wi, and dividing it by the K×K window, and storing it in a memory corresponding to a position that each data occupies in the K×K window. The relationship may be expressed as follows.

PA(physical memory internal address)=└(i % W)/K┘

PM(physical memory to be used)=└i/W┘%K*K+(i % W)% K

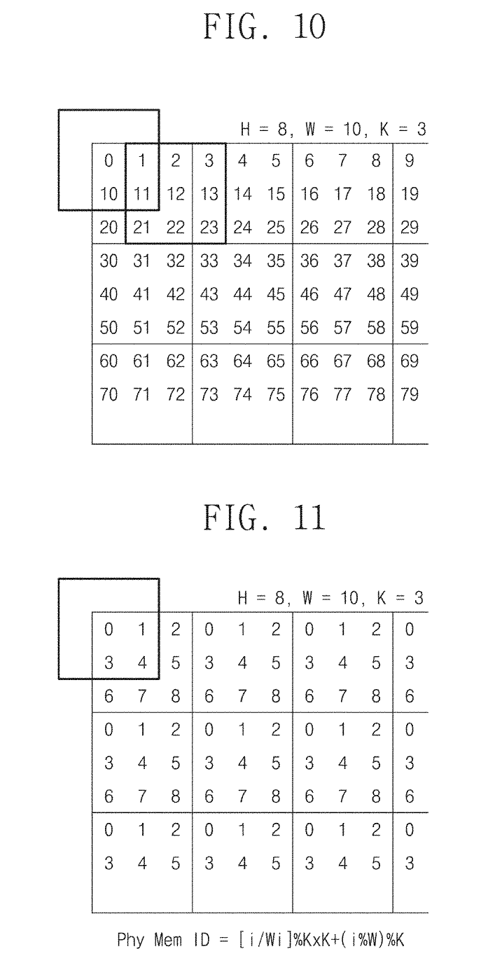

FIG. 10 is a view illustrating an example of an index of input data according to an embodiment of the inventive concept. Referring to FIG. 10, it is the case of K=3, Wi=10, and Hi=8. The number indicates the index of the input data in the input FM (in the case of Hi=8, Wi=10, and K=3). Here, no matter where a grid is positioned when moving, each data in the K×K grid may be allocated to physically different memory to be output later at the same time. When data is input, the entire data may be divided by the K×K size of window (i.e., the black grid) so that the data therein may be physically allocated to another memory.

FIG. 11 is a view illustrating an example of a physical memory number selected by an index of input data according to an embodiment of the inventive concept. Referring to FIG. 11, there are K×K bottom buffers 145 (M₀ to M_{K×K-1}), and as shown in FIG. 11, it shows a method of calculating which memory (Phy Mem ID) is to be selected in the data index and its result.

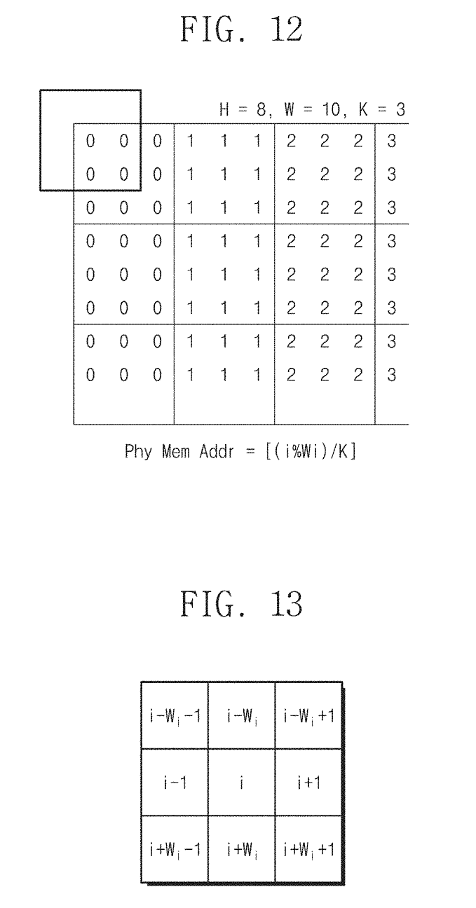

FIG. 12 is a view illustrating an address for the data to be stored in the selected physical memory according to an embodiment of the inventive concept. Referring to FIG. 12, when a memory is selected, it shows at which address the data should be stored in the memory. Since only K lines need to be stored at an instant, when a new data line is loaded, there is no problem to overwrite data at the position of the used line. In the above, % operation or operation may be easily implemented through a counter. Therefore, when some bottom data is input, if an address (i.e., index) in an FM is known, the above-described method may calculate which physical memory the data is to be stored and which address the data is to be stored.

Furthermore, the kernel buffer 140 and the bottom buffer 145 are memory for storing kernel data and input data as described with reference to the input data load unit 130. In an embodiment, the kernel buffer 140 and the bottom buffer 145 may be implemented using synchronous random access memory (SRAM).

The inventive concept reads input FM and changes kernel window with input data selection thus generating in parallel the output FM points, P values at a time. In this process, previous intermediate result of each output may be read to produce new result.

The kernel/data supply unit 150 may receive commands from the control unit 110 and may read the K×K input data corresponding to the kernel window from the input data buffers 140 and 145 depending on the row and column index of the output FM to be generated in correspondence to such a processing order.

In addition, the kernel/data supply unit 150 may sequentially read the P K×K kernels and for each K×K input data switches P K×K kernel weights sequentially required to generate all output partial sums at the following convolution block. The convolution block may make successive P values using this supplied data. That is, the kernel/data supply unit 150 may read and output the kernel window data in the bottom buffer 145, and for the selected data, read the kernel buffer data and generates P K×K weight values ┌N/P┐ times.

Furthermore, the pipeline parallel kernel processing unit 160 may use kernel data and input data to generate partial or final output data in a pipeline manner.

In the following, reading the kernel buffer 140 will be described.

When reading data from the kernel buffer 140, the data should be realigned to the format used in kernelling. Kernel reading uses state machine or counters (index) and for each kernel window location, changes kernels P kernels at a time and repeats this ┌N/P┐ times for a kernel window location. This is possible by reading kernel DPRAM from read address 0 to ┌N/P┐−1 and reading P K×K weights from P×K memories (M_{p,r} parallel processing p=0˜P−1, kernel row number r=0˜K−1) and aligning and outputting them.

In the below, reading a bottom data buffer will be described.

When the memory selected for writing the bottom into is Mi, and the data index in the 2-D input feature map is i=Wixrow_index+col_index, it is stored in Mₕ and the address in Mₕ is A. The h and A may be expressed as below.

h=└(i % W)/K┘

A=└i/W┘% K*K+(i % W)% K

Therefore, even when the kernel window is moved, if the K×K data's address (index i above) is known, it is possible to calculate the memory id and the address inside the memory.

FIG. 13 is a view illustrating an example of an index calculation of other values from a kernel center index according to an embodiment of the inventive concept. Referring to FIG. 13, for example, when K=3, it indicates a data index corresponding to a kernel window. The center data index is i.

As explained, if the center data's index is known, the memory and address of the data inside the current kernel window can be selected. If the index goes out of FM (feature map) boundary, the index may be clipped to zero, and if not, the selected memory and the selected address may be read. (In another similar implementation, this memory selection and address increment is implemented by applying increment condition to each and this method can be used too.).

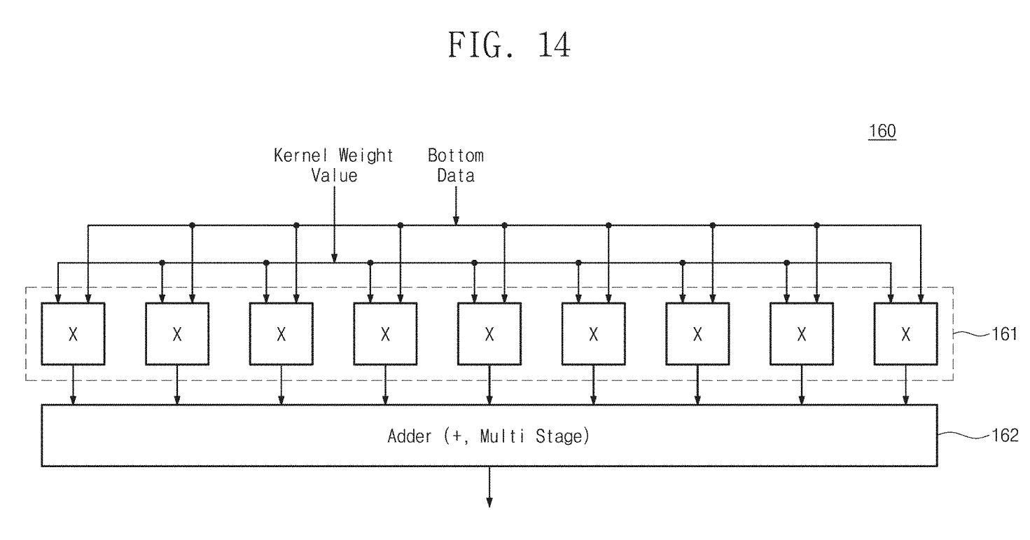

FIG. 14 is an exemplary view illustrating a pipeline parallel kernel processing unit 160 according to an embodiment of the inventive concept. Referring to FIG. 14, the pipeline parallel kernel processing unit 160 may perform a convolution operation using K×K bottom data and P×K×K kernel weight values, which are output from the kernel/data supply unit 150, and may generate P convolution sums. There are P (for example, 2) pipeline parallel kernel processing units 160 shown in FIG. 14 in terms of a structure. A multiplier 161 and an adder 162 may use the same precision as the data. A pipeline operation may be used to generate convolution results every clock.

The result reception unit 170 may be implemented to receive intermediate result (the previous partial sum) data output from the pipeline parallel kernel processing unit 160 and accumulate it in a corresponding external memory. The M partial sums read from external memory may be grouped into P values and stored in the FIFO inside the result reception unit 170. This partial sum is output synchronized to the arrival of the new calculations and after being added with these new calculations from the kerneling block, stored in the partial top buffer memory 180 in 128 bit groups with incrementing address.

The FIFO to store the partial sum has a width of P×W (W is in single precision case 32), and a depth is ┌N/P┐.

In addition, the partial top buffer 180 after the partial sum storage has a width of 128 bits and a depth of N/4. The partial top buffer 180 may be implemented to store the intermediate result of the result reception unit 170.

The data storing block reads the partial or final sum from the top buffer 180 and stores it to the external memory through DMA. Commanded by the control unit 110, it reads the partial sum data in the top buffer memory 180 sequentially and sends it to DMA processing unit 120 in 128 bit units when DMA processing unit 120 has a space in its write FIFO

Output data is in the form of successively locating output feature map data for the same location of M output feature maps, when it is written out to AXI, and should be written with Wo×Ho offset (or stride), or they can be written in 32 bit units. Another method includes gathering the data and writing in burst.

The offset (or stride) between data in output feature map in large case (for example, in 600*800 map, it becomes 0x75300), exceeds DDR3 memory's single row interval and increases the access time and reduces the burst write speed. Method of writing interleaved format and reading and realigning for the next convolution layer can also be used. DMA processing block when its internal write FIFO has a data, reads the FIFO and writes the data in 128 bits to AXI bus.

The convolution circuit 100 according to an embodiment of the inventive concept may use M×N K×K kernels in the external memory, may receive M input FMs from the external memory and may generate N output FMs to the external memory.

In the embodiment, the convolution circuit 100 may receive a convolution start command together with information such as the number and size of input/output FMs, the size of a kernel, the address where an input FM and a kernel start, and the address where an output FM should be positioned and may create an output FM. The method is a scheme of reading an input FM one by one. If the intermediate result of the output FM, which is obtained by processing and calculating the previous input FM, is in the external memory, after reading the value and then reading N kernels for creating each output FM from the input FM currently being processed, through a method of repeating the storing of the updated value obtained by adding the result value obtained by convolution-processing the input FM to the previously processed intermediate result, the output FM may be created.

In an embodiment, when the convolution circuit processes the input FM currently processed, the data of the input FM may process the input FM with a row unit and a column unit in a row.

In an embodiment, when fetching data necessary for a kernel memory from an external memory, the convolution circuit reads with a line unit to allow rows including the data necessary for the kernel window of the data to be processed to be in a chip, and allows data of K rows in the input FM to be in the chip always.

In an embodiment, when the input FM data is loaded into the chip, the convolution circuit may physically divide the input FM data and store it in a plurality of memories so as to simultaneously output K×K adjacent input data to be processed by the kernel window.

In an embodiment, the convolution circuit may store data to be used in each physical memory to be in different addresses.

In an embodiment, the convolution circuit may select the necessary K×K input data according to the selected kernel window position.

In an embodiment, in order to parallelize the value of the same position of several output FMs at the same time for the selected input data, the convolution circuit may select the required number of K×K kernels in parallel.

In an embodiment, generating the intermediate result of the input FM in parallel through processing together with the input data is repeated, and when the intermediate result value of the same position of all output FMs are processed, the convolution circuit may store the result value.

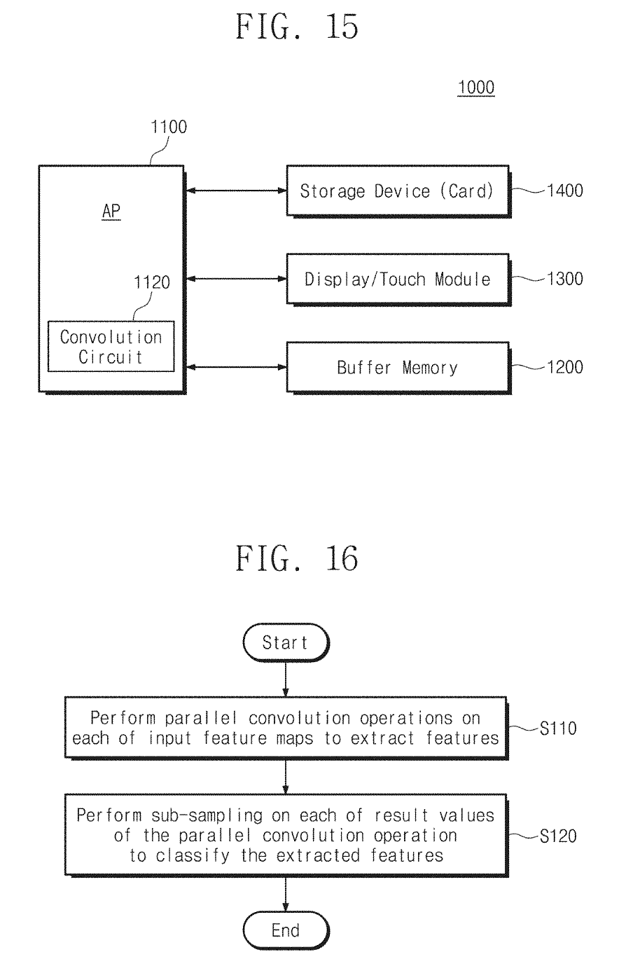

FIG. 15 is a view illustrating a mobile device 1000 according to an embodiment of the inventive concept. Referring to FIG. 15, the mobile device 1000 may include a processor (e.g., AP/ModAP) 1100, a buffer memory 1200, a display/touch module 1300, and a storage device 1400.

The processor 1100 may be implemented to control the overall operation of the mobile device 1000 and the wired/wireless communication with the outside. For example, the processor 1100 may be an application processor (AP), an integrated modem application processor (ModAP), or the like.

The processor 1100 may include a convolution circuit 1120. The convolution circuit 1120 may be implemented to perform the convolutional neural network operation described in FIGS. 1 to 14. For example, the convolution circuit 1120 may be implemented using the convolution circuit 100 shown in FIG. 6.

The buffer memory 1200 may be implemented to temporarily store data necessary for the processing operation of the mobile device 1000. In an embodiment, the buffer memory 1200 may be implemented using a DRAM, an SDRAM, an MRAM, or the like. Here, the buffer memory 1200 may be implemented using the external memory shown in FIG. 6.

The display/touch module 1300 may be implemented to display data processed by the processor 1100 or receive data from the touch panel.

The storage device 1400 may be implemented to store user data. The storage device 2400 may be an embedded multimedia card (eMMC), a solid state drive (SSD), a universal flash storage (UFS), or the like.

The storage device 1400 may include at least one non-volatile memory device.

The mobile device 1000 according to the embodiment of the inventive concept may recognize the image using the CNN, thereby providing efficient recognition.

FIG. 16 is a flowchart illustrating an operation method of the AP 1100 according to an embodiment of the inventive concept. Referring to FIGS. 15 and 16, an operation method of the AP 1100 is as follows.

The convolution circuit 1120 of the AP 1100 may perform parallel convolution operations on each of the input FMs to extract features (S110). Here, the performing of the parallel convolution operations may include receiving intermediate results or input data from an external memory and outputting intermediate result values to the external memory at the same time. Thereafter, the application processor 1100 may perform sub-sampling operations on each of the result values of the parallel convolution operations for classification by using the extracted features (S120).

A convolution circuit according to an embodiment of the inventive concept and an operation method thereof may have a relatively short processing time through parallel processing while using a minimum memory. Accordingly, a convolution circuit according to an embodiment of the inventive concept and an operation method thereof may use deep learning in an AP including a CPU core.

Although the exemplary embodiments of the inventive concept have been described, it is understood that the inventive concept should not be limited to these exemplary embodiments but various changes and modifications can be made by one ordinary skilled in the art within the spirit and scope of the inventive concept as hereinafter claimed.

What is claimed is:

1. An operation method of a convolution circuit, the method comprising:
receiving input feature maps;
generating output feature maps corresponding to the respective input feature maps through convolution operations by performing parallel processing with a kernel unit; and
outputting the output feature maps to an external memory.

2. The method of claim 1, wherein the kernel unit is K×K window filtering (K is a natural number).

3. The method of claim 2, further comprising storing K lines of each of the input feature maps in an internal memory of a chip.

4. The method of claim 2, wherein the generating the output feature maps comprises storing kernels necessary for generating the output feature maps in the external memory.

5. The method of claim 1, further comprising repeating loading and accumulating a partial sum of the convolution operation from the external memory, or storing the partial sum in the external memory.

6. The method of claim 1, at least one of the parallel processing convolutions may use a physically different memory for its data multiplied by the kernel weights.

7. The method of claim 1, wherein result values of each of the convolution operations are stored in the external memory in a predetermined order.

8. The method of claim 1, wherein at least one of the convolution operations is performed while outputting at least one of the output feature maps to the external memory.

9. The method of claim 1, wherein a plurality of feature map data are output at the same time while receiving the plurality of feature map data from the external memory.

10. A convolution circuit comprising:
a direct memory access (DMA) processing unit configured to read data from an external memory or output data to the external memory;
a kernel buffer configured to store kernel data for connecting an input feature map being processed and N output feature maps;
a bottom buffer configured to store a plurality of input data corresponding to an input feature map;
an input data load unit configured to store the N kernel data and M input feature map data from the DMA processing unit into the kernel buffer;
a kernel/data supply unit configured to output P (P is a natural number of 2 or more) K×K input data of the bottom buffer and P K×K kernel data of the kernel buffer;
a pipeline parallel kernel processing unit configured to perform a convolution operation to the K×K input data by using K×K kernel weight values for each P kernel processing;
a result reception unit configured to receive a result value of the pipeline parallel kernel processing unit;
a partial top buffer configured to store the intermediate result values; and
a control unit configured to control the DMA control unit, the kernel buffer, the bottom buffer, the input data load unit, the kernel/data supply unit, the pipeline parallel kernel processing unit, the result reception unit, and the partial top buffer.

11. The convolution circuit of claim 10, wherein the DMA processing unit comprises:
a read first-in, first-out (FIFO) memory configured to store a plurality of input feature map data and kernel data from the external memory; and
a write FIFO memory configured to store a plurality of output feature map data to be written in the external memory.

12. The convolution circuit of claim 10, wherein the kernel buffer is implemented as a dual port random access memory (DPRAM) for storing the N kernel data and outputting the P kernel data for parallel processing at the same time.

13. The convolution circuit of claim 11,
wherein the kernel buffer further loads kernel data from the external memory in an order of an input feature map, and loads kernel data to a memory in an order of processing output feature maps when processing the input feature map, and
wherein a storage order of each kernel data is to store the kernel data with a row unit first and then to store the kernel data with a column unit in each row.

14. The convolution circuit of claim 13, wherein the kernel buffer further allocates a different physical memory for each row of a kernel.

15. The convolution circuit of claim 11, wherein the kernel buffer collects the K weight values from the read FIFO memory and stores the K weight values in a corresponding memory.

16. The convolution circuit of claim 11, wherein the bottom buffer outputs all data in a kernel window at the same time while the kernel window for input data moves in the input feature map.

17. The convolution circuit of claim 16, wherein the kernel/data supply unit further reads input data corresponding to the kernel window from the bottom buffer according to a row and column index of an output feature map and read the P kernel data for processing the data read from the kernel buffer.

18. The convolution circuit of claim 17, wherein the pipeline parallel kernel processing unit outputs the P result values by performing a multiplication operation and an addition operation on the input data and corresponding kernel weight values delivered from the kernel/data supply unit.

19. The convolution circuit of claim 11, further comprising an output data storage unit configured to read the intermediate result values from the partial top buffer and transmit the accumulated intermediate result values to the write FIFO memory of the DMA processing unit.

20. An operation method of an application processor, the method comprising:
performing parallel convolution operations on each of input feature maps to extract features; and
performing sub-sampling operations on each of result values of the parallel convolution operation to extract the features,
wherein the performing of the parallel convolution operations comprises outputting intermediate result values to an external memory at the same time while receiving input data from the external memory.
